(19) United States
(12) Patent Application Publication
(10) Pub. No.: US 2024/0081299 A1
(43) Pub. Date: Mar. 14, 2024

(54) AQUARIUM CORNER INTEGRATION FRAME

(71) Applicant: KinFai Cheung, Shaoguan (CN)

(72) Inventor: KinFai Cheung, Shaoguan (CN)

(21) Appl. No.: 18/517,692

(22) Filed: Nov. 22, 2023

(30) Foreign Application Priority Data
Dec. 28, 2022 (CN) 202223537590.0

(51) Int. Cl. A01K 63/00; A01K 63/04

(52) U.S. Cl. CPC A01K 63/006; A01K 63/045

(57) ABSTRACT

The present application discloses an aquarium corner integration frame and relates to the field of aquarium accessories. The aquarium corner integration frame comprises a water inlet integration frame and a water outlet integration frame. The water inlet integration frame comprises a first main body and a first door plate, and the first door plate is fastened with the first main body; and the water outlet integration frame comprises a second main body and a second door plate, and the second door plate is easterner with the second main body. Under the circumstances of without deteriorating the effectiveness and efficiency of the aquarium equipment, the present application reduces the use of space and visual space of aquariums which are occupied by equipment and wires, and provides new solutions for improving the water quality and the ornamental feature of aquarium.

### TECHNICAL FIELD

The present application relates to the technical field of aquarium accessories, and in particular to an aquarium corner integration frame.

### BACKGROUND

An aquarium is a special container for raising aquatic plants and animals, and it plays an ornamental role in living. To protect the small ecologic environment in the aquarium, it is generally required to equip devices such as water surface skimmers, heating rods and atomizers and other equipment. However, such devices occupy the much space of the aquarium, furthermore, the devices and their messy wires will deteriorate the ornamental feature of the aquarium. Moreover, some devices are required to be fixed on the glass of the aquarium by using suction cups, which further increase the visual area occupied of the aquarium when it is viewed from the outside of the aquarium, hence the ornamental feature will further be deteriorated. In addition, a common practice is to use high and large underwater plants to hide the various devices and messy wires during aquascaping, which affects the feasibility of aquarium design. Under the above circumstance, the applicant is dedicated to developing an aquarium corner integration frame to further improve the ornamental feature and the aquascaping feasibility.

### SUMMARY

The objectives of the present application are improving the ornamental feature of aquarium and further increasing the feasibility of aquascaping.

To achieve the above objectives, the present application implements the following technical solution:

An aquarium corner integration frame comprises a water inlet integration frame and a water outlet integration frame,

The water inlet integration frame comprises a first main body and a first door plate, water inlets are set at the first door plate, at least one group of first water pipe openings are set at the top surface of the first main body, and the first door plate is buckled with the first main body; and

the water outlet integration frame comprises a second main body and a second door plate, water outlets are set at the second door plate, at least one group of second water pipe openings are set at the top surface of the second main body, and the second door plate is buckled with the second main body.

Further, the water inlet integration frame further comprises first aquarium wall buckles, first lugs are set at the top surface of the first main body, the first aquarium wall buckles are fixed under the first lugs with screws, and first wire clamping groove are set at the first aquarium wall buckles.

Further, filter nets are clamped at the water inlets.

Further, an water surface skimmer is mounted in the first main body.

Further, the water inlet integration frame further comprises first door plate buckles and first hooks, the first door plate buckles are set on the first main body, and the first hooks are set on the first door plate and buckled with the first door plate.

Further, the water outlet integration frame further comprises second aquarium wall buckles, second lugs are set at the top surface of the second main body, the second aquarium wall buckles are fixed under the second lugs with screws, and second wire clamping groove are set at the second aquarium wall buckles.

Further, a fixed partition plate is set in the second main body and separates an interior space of the second main body into a first storage space and a second storage space, and a group of openings are set at the fixed partition plate and vertically formed at the fixed partition plate.

Further, the water outlet integration frame further comprises a water inlet pipe, one end of the water inlet pipe is connected with the interior of the first storage space, and a cross-section of the connection area of the water inlet pipe and the first storage space is oval.

Further, the water outlet integration frame further comprises storage baskets, and the storage baskets provide hanging buckles for being fixed to the openings set at the fixed partition plate through the hanging buckles.

Further, the water outlet integration frame further comprises second door plate buckles and second hooks, the second door plate buckles are set on the second main body, and the second hooks are set on the second door plate and buckled with the second door plate.

The present application has the beneficial effect that the water inlet integration frame is formed by buckling the first door plate and first main body, and the water outlet integration frame is formed by buckling the second door plate with the second main body. When it is in practice, the water inlet integration frame and the water outlet integration frame are installed at two corners of the aquarium by clamping the aquarium wall with the aquarium wall buckles, and various aquarium equipment and devices are installed at the water inlet integration frame and the water outlet integration frame compactly, thus the interior space in aquarium which occupied by the devices in the aquarium is combined, it greatly increases the ornamental feature of the aquarium; in another aspect, when the aquarium corner integration frame is installed at two corners of the aquarium, it makes the wires of equipment be integrated, and visual space occupied by the wires of the aquarium is greatly reduced.

### BRIEF DESCRIPTION OF THE DRAWINGS

FIG. 1 is a structural schematic diagram when a water inlet integration frame and a water outlet integration frame are set in an aquarium of the present application.

FIG. 2 is a structural schematic diagram of a water inlet integration frame of the present application.

FIG. 3 is a structural exploded diagram of a water inlet integration frame of the present application.

FIG. 4 is a structural schematic diagram when the first main body and the first door plate are separated from each other in the present application.

FIG. 5 is a structural schematic diagram of the water surface skimmer for the floating water inlet and water inlet adapter of the present application.

FIG. 6 is a structural schematic diagram of a water outlet integration frame of the present application.

FIG. 7 is a structural schematic diagram when a second main body and a second door plate are separated from each other of the present application.

FIG. 8 is a transverse cross-sectional schematic diagram of a second main body and a second door plate of the present application.

FIG. 9 is a structural exploded diagram of a water outlet integration frame of the present application.

### REFERENCE NUMERALS

First main body 11, water surface skimmer 111, floating water inlet 1111, water inlet adapter 1112, first lug 112, first door plate 12, water inlet 121, filter net 122, first aquarium wall buckle 13, first wire clamping grooves 131, first door plate buckle 14, first hook 15, water inlet pipeline 16, second main body 21, second water pipe opening 211, second lug 212, second door plate 22, water outlet 221, wire opening 222, second aquarium wall buckle 23, second wire clamping grooves 131, water inlet pipe 24, storage basket 25, second door plate buckle 26, second hook 27, fixed partition plate 28, first storage space 281, second storage space 282, fixed partition opening 283, heating rod 29, atomizer 30.

### DETAILED DESCRIPTION OF THE EMBODIMENT

The present application will be further described below in combination with the accompanying drawings.

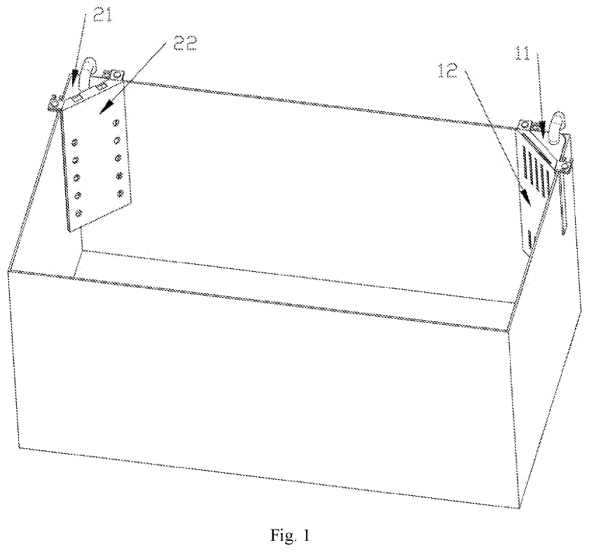

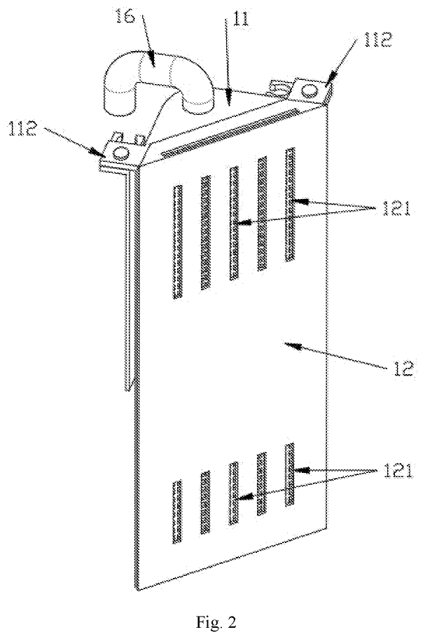

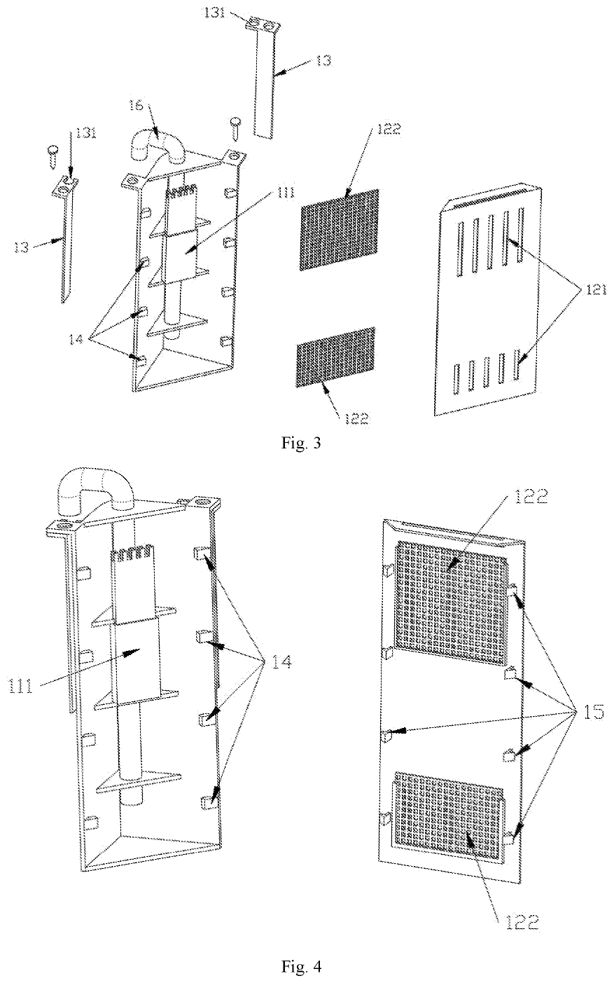

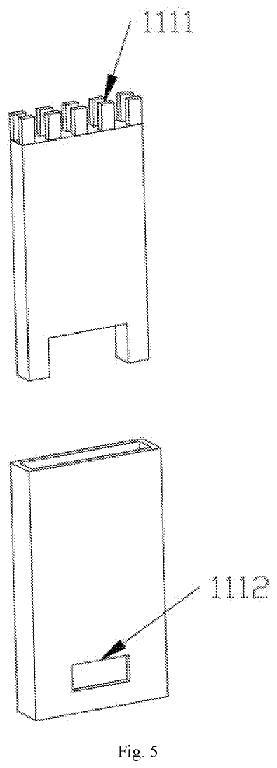

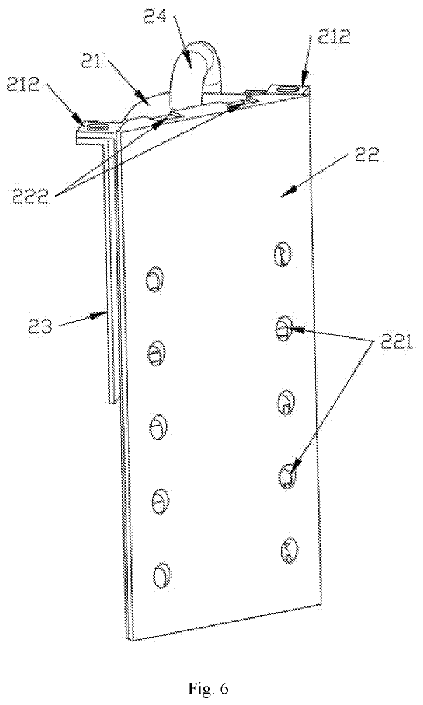

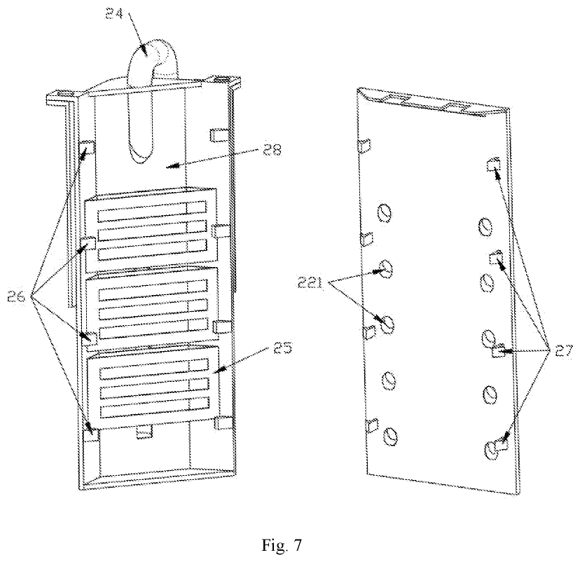

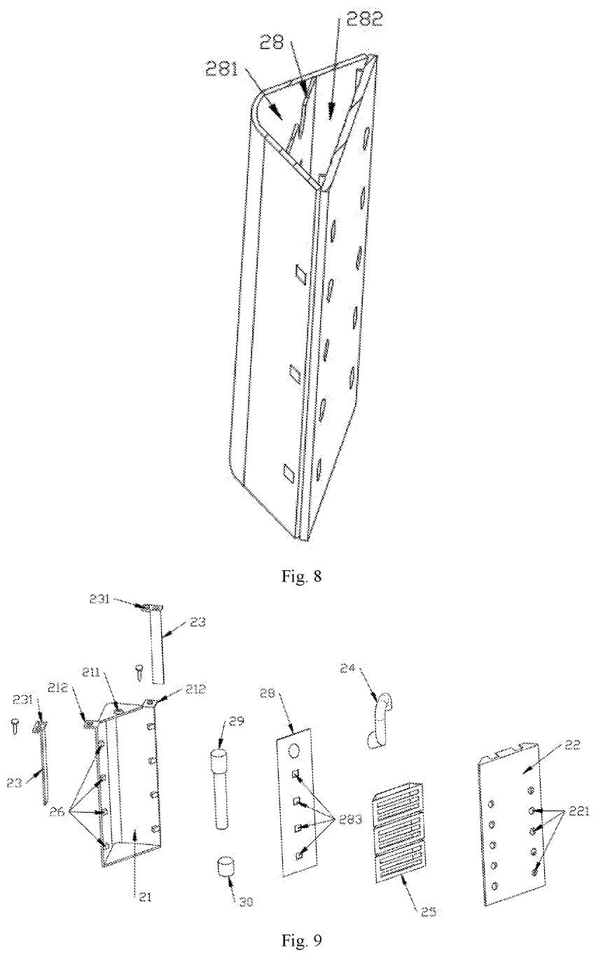

An aquarium corner integration frame, as shown in FIGS. 1-9, comprises a water inlet integration frame and a water outlet integration frame. The back of the water inlet integration frame and the water outlet integration frame are both arc-shaped, to prevent the both water inlet integration frame and the water outlet integration from scratching adhesives at corners of the aquarium.

The water inlet integration frame comprises a first main body 11, a first door plate 12, first aquarium wall buckles 13, first door plate buckles 14 and first hooks 15. Water inlets 121 are formed in the first door plate 12; at least one group of first water pipe openings are formed at the top surface of the first main body 11; the first door plate 12 is buckled with the first main body; and the water inlets 121 allow water enter the water surface skimmer 111 and go through to water inlet pipeline 16 to finally enter the water filtering system of the aquarium.

First lugs 112 are set at the top surface of the first main body 11; the first aquarium wall buckles 13 are fixed under the first lugs 112 with screws; and the first wire clamping grooves 131 are set at the first aquarium wall buckles 13. The first wire clamping grooves 131 is designed with openings for clamping wires and air tubes of equipment of interior storage spaces of the corner integration frame, it solves the problem of messy equipment wires and further be available for clamping other equipment such as scissors, aquatic plants clamps or fishing nets.

Filter nets 122 are clamped at the water inlets 121; and the water surface skimmer 111 is mounted in the first main body 11.

The water surface skimmer 111 is formed by two components which are floating water inlets 1111 and water inlet adapter 1112. The floating water inlets 1111 is a non-fixed floating component, and 2 protrusion parts are formed at the bottom side of the floating water inlets 1111; when the 2 protrusion parts are working, the floating water inlets 1111 floats accompanied by the height of surface water level in the aquarium, and the available floating height of the floating water inlets 1111 cannot exceed the height of the first door plate 12, to prevent the situation that when the first door plate 12 is installed and the surface water in aquarium is over height, then the floating water inlets 1111 will disengage with the water inlet adapter 1112 when it is floating accompany with the height of surface water level in the aquarium.

The water inlets of the water surface skimmer 111 is a non-fixation device and its component of floating water inlets 1111 can float accompanied by the height of the water level of the aquarium. Generally, algae and oil firm of surface water are both significant problems for aquarium, to deal with the algae problem of aquarium, a certain number of creatures such as fishes, shrimps, and snails that function as cleaning tools are required to be raised in the aquarium. Such creatures are usually in tiny size and easy to be sucked into water inlet of water surface skimmers due to its tiny sizes, because it is common for many aquarium filters and water surface skimmers in the market, that making the water surface skimmer using relatively large gaps at the floating water inlets, to make it be able to keep floating with large quantity of water flowing through, it is unfriendly to the fishes and the shrimps and other creatures that they are easy to be sucked into the relatively large gaps of the water inlets of filtering equipment; therefore there are many owners of aquarium do not turn on the water surface skimmers and filters frequently for preventing fishes and shrimps and other creatures from being sucked into the water surface skimmers and filtering systems. In this embodiment, the filter nets 122 are clamped at the water inlets 121; water in the aquarium firstly enters the first main body 11 through the filter nets 122, then arrives the inlets of water surface skimmer 111 through the floating water inlets 1111 and enters the water inlet pipeline 16 and finally enter the filtering system of the aquarium, to process the filtering for oil firm of surface water in aquarium; and the filter nets 122 has a function of preventing the fishes, shrimps and other creatures from entering the water surface skimmer 111.

The first door plate buckles 14 are set at the first main body 11; the first hooks 15 are set at the first door plate 12; and during assembly, the first hooks 15 are fastened with the first door plate buckles 14, then the first main body 11 is combined with the first door plate 12.

The outside surface of the first door plate 12 is smooth; and users are available to choose to attach other equipment fixed with suction cups on the outside surface of the first door plate 12.

The water outlet integration frame comprises a second main body 21, a second door plate 22, second aquarium wall buckles 23, a water inlet pipe 24, storage baskets 25, second door plate buckles 26, and second hooks 27. Water outlets 221 are formed at the second door plate 22; at least one group of second water pipe openings 211 are formed at top surface of the second main body 21; the second door plate 22 is buckled with the second main body 21; two wire openings 222 are reserved on the second door plate 22; and the wires and air tubes of equipment, which wiring from the second main body 21 are available to go through the two wire openings 222 and then be fixed at the second wire clamping grooves 131 for tidying up, and further to connect to aquarium related devices.

Second lugs 212 are set at the top surface of the second main body 21; the second aquarium wall buckles 23 are fixed under the second lugs 212 with screws; and second wire clamping grooves 231 are formed at the second aquarium wall buckles 23. The second wire clamping grooves 231 are designed with openings prepared for clamping wires and air tubes of the equipment in the storage space of the water outlet integration frame, and it is able for clamping other equipment such as scissors, aquatic plants clamps, and fishing nets, for tidying up equipment and messy wires.

A fixed partition plate 28 is set inside the second main body 21 and it separates the interior space of the second main body 21 into a first storage space 281 and a second storage space 282; the users can choose to install devices such as a heating rod 29 and an atomizer 30 in the second storage space 282; a group of openings 283 are vertically formed in the fixed partition plate 28; and water come from filtering system firstly flows into the first storage space 281, then flows to the second storage space 282 through the openings on 283, and then water flows into the aquarium through the water outlets 221 on the second door plate 22. The direction of water outlets 221 is designed as inclined upward, for allowing the water to flow in a way of inclined upward in aquarium, thus the water flow is prevented from directly impacting aquatic plants and soil bed in the middle and down direction of the aquarium, and it is also preventing the water flowing from re-entering the filtering system of aquarium too early because the water draining direction is avoiding to flow to the water inlet 121.

One end of the water inlet pipe 24 is connected with the storage space 281. Specifically, one end of the water inlet pipe 24 penetrates the top surface of the second main body 21 and the fixed partition plate 28, and then connects with the first storage space 281; and the cross-section of the connecting part of the water inlet pipe 24 and the first storage space 281 is oval, the water inlet pipe 24 is inclined downward to the fixed partition 28, such design has the advantages that impacting force of the water flowing is being dispersed, and water pressures in the first storage space 281 and the water inlet pipe 24 is relieved.

The storage baskets 25 provides hanging buckles and able to be fixed with the openings 283 on the fixed partition plate 28 through the hanging buckles. The storage baskets 25 are available for loading aquarium tools such as bacterium cultivation balls, deacidification shell powder, water softening resin, and other water quality controlling tools and materials, and when storage baskets 25 is not installed, other beneficial aquarium devices are available to be mounted at the fixed partition plate 28 in the second storage space 282.

The second door plate buckles 26 are set at the second main body 21; and the second hooks 27 are set at the second door plate 22.

The outside surface of the second door plate 22 is smooth. When users want to install some large equipment such as thermometers and heating rods, if the equipment size is not capable of being placed inside the water outlet integration frame, users are able to choose to install the equipment on the outside surface of the second door plate 22 with suction cups.

Compare with current market products practice, the present application provides the water surface skimmer 111 of the water inlet integration frame which is an integration frame built-in type, and a layer of filter nets 122 is additionally protecting the water inlet integration frame from preventing the small creatures in aquarium such as fishes, shrimps and other creatures that is easy to be sucked into the water inlet integration frame; and the water outlet integration frame is compatible to install different equipment and tools in the storage space for controlling and adjusting the water quality, and it drains the water in an inclined upward way, which allows the water flowing as a way of inclined upward in aquariums.

The present application has the working principle that: the first aquarium wall buckles 13 are fixed under the first lugs 112 with screws, then the first main body 11 be clamped to one corner of the aquarium by clamping the aquarium wall with the aquarium wall buckles 13; and the second aquarium wall buckles 23 are fixed under the second lugs 212 with screws, then the second main body 21 be clamped to another corner of the aquarium by clamping the aquarium wall with the aquarium wall buckles 23. Water in the aquarium flows through the filter nets 122 and then enters the first main body 11, thus the fishes and the shrimps, and other creatures are prevented to be sucked into the water surface skimmer 111; and when the water surface skimmer 111 works, the oil firm of surface water in the first main body 11 will be sucked into the water surface skimmer 111 and further arrives the filtering system through the water inlet pipeline 16.

The filtered water enters the first storage space 281 through the water inlet pipe 24 and flows into the second storage space 282 through the openings 283 of the fixed partition plate 28; water in the second storage space 282 is heated through the heating rod 29, and then it is drained inclined upward through the water outlets 221 of the second door plate 22, thus the water flowing is prevented from impacting the aquatic plants and the soil bed in aquarium, and also prevented the water flowing from re-entering to the filtering system too early. The second storage space 282 is compatible with other devices for adjusting the water quality.

The present application has an overall design idea that the visual area occupied by the equipment wires inside and outside the aquarium is reduced; and without deteriorating the efficiency and effectiveness of the aquarium equipment, some equipment and wires of the aquarium are combined and integrated in the corner integration frame, which provides a new solution for improving the water quality and the ornamental feature of the aquarium.

The above are only preferred embodiment of the present application and are not intended to limit the protection scope of claims of the present application. Therefore, all equivalent changes made according to the application patent scope of the present application shall be within the scope of the present application. The above description is not intended to limit the technical scope of the present application in any form. Any modifications, equivalent changes and embellishments made to the above embodiments according to the technical substance of the present application all fall within the scope of technical solutions of the present application.

What is claimed is:

1. An aquarium corner integration frame, comprising a water inlet integration frame and a water outlet integration frame, wherein:
The water inlet integration frame comprises a first main body and a first door plate, at least one group of water inlet holes are set at the first door plate, at least one group of first water pipe openings are set at the top surface of the first main body, and the first door plate is buckled with the first main body; and
The water outlet integration frame comprises a second main body and a second door plate, water outlets are set at the second door plate, at least one group of second water pipe openings are set at the top surface of the second main body, and the second door plate is buckled with the second main body.

2. The aquarium corner integration frame according to claim 1, wherein the water inlet integration frame further comprises first aquarium wall buckles, first lugs are set at the top surface of the first main body, the first aquarium wall buckles are fixed under the first lugs with screws, and first wire clamping groove are set at the first aquarium wall buckles.

3. The aquarium corner integration frame according to claim 1, wherein filter nets are clamped at the water inlets.

4. The aquarium corner integration frame according to claim 1, wherein a water surface skimmer is mounted in the first main body.

5. The aquarium corner integration frame according to claim 1, wherein the water inlet integration frame further comprises first door plate buckles and first hooks, the first door plate buckles are set on the first main body, and the first hooks are set on the first door plate and buckled with the first door plate.

6. The aquarium corner integration frame according to claim 1, wherein the water outlet integration frame further comprises second aquarium wall buckles, second lugs are set at the top surface of the second main body, the second aquarium wall buckles are fixed under the second lugs with screws, and second wire clamping grooves are set at the second aquarium wall buckles.

7. The aquarium corner integration frame according to claim 1, wherein a fixed partition plate is set in the second main body and separates the interior space of the second main body into a first storage space and a second storage space, and a group of openings are set at the fixed partition plate and vertically formed at the fixed partition plate.

8. The aquarium corner integration frame according to claim 7, wherein the water outlet integration frame further comprises a water inlet pipe, one end of the water inlet pipe is connected with the first storage space, and the cross-section of the connection area of the water inlet pipe and the first storage space is oval.

9. The aquarium corner integration frame according to claim 7, wherein the water outlet integration frame further comprises storage baskets, and storage baskets provide hanging buckles for being fixed to the openings set at the fixed partition plate through the hanging buckles.

10. The aquarium corner integration frame according to claim 1, wherein the water outlet integration frame further comprises second door plate buckles and second hooks, the second door plate buckles are set on the second main body, and the second hooks are set on the second door plate and buckled with the second door plate.
